(19) United States
(12) Patent Application Publication
(10) Pub. No.: US 2025/0242668 A1
(43) Pub. Date: Jul. 31, 2025

(54) DEVICE FOR ADJUSTING VANES OF AN AIR OUTLET AND AIR OUTLET

(71) Applicant: Faurecia Innenraum Systeme GmbH, Hagenbach (DE)

(72) Inventors: Martin SCHUMM, Karlsruhe (DE); Volker DOLL, Ranschbach (DE)

(21) Appl. No.: 19/032,767

(22) Filed: Jan. 21, 2025

(30) Foreign Application Priority Data
Jan. 26, 2024 (DE) 10 2024 200 706.4

(51) Int. Cl. B60H 1/34

(52) U.S. Cl. CPC B60H 1/3421; B60H 2001/3464; B60H 2001/3471

(57) ABSTRACT

A device for adjusting vanes of an air outlet may have a motor having an output shaft for selectively adjusting a first part of the vanes and a second part of the vanes different from the first. The device may also have a motor crank driven by the output shaft and rotatable about a main rotation axis. The device may have a first actuation element and a second actuation element, a first adjustment crank rotatable about a first rotation axis and a first engagement element in which the first actuation element engages or is engageable for rotating the first adjustment crank. A second adjustment crank rotatable about a second rotation axis and having a second engagement element in which the second actuation element engages or is engageable for rotating the second adjustment crank may also be provided.

### FIELD

The present property right relates to a device for adjusting vanes of an air outlet and to an air outlet comprising the device. The device can be provided in particular for an air outlet that is part of a ventilation system of a vehicle interior.

### BACKGROUND

Air outlets, in particular air outlets for a vehicle interior, typically comprise adjustable vanes that can guide an air flow provided in the air outlet into the vehicle interior in a specific direction. The air flow direction is expediently broken down into two components, wherein a first part of the vanes controls the air flow along one direction component and a second part of the vanes controls the air flow along the other direction component. It may also be expedient to control or adjust the two directional components and thus the corresponding vanes selectively, i.e. at least partially independently of one another. To further increase ease of use, the vanes can be adjusted by means of a motor, i.e. electromechanically, for example. Typically, two separate motors are used for this, each adjusting the first or second part of the vanes. However, for cost and maintenance reasons, it may be desirable to eliminate one of the two motors, even if this means having to accept a more complicated drive mechanism in order to still be able to adjust both parts of the vanes by means of a motor.

Corresponding devices for adjusting vanes by means of a single motor are known in the prior art, but usually comprise drive mechanisms that are complex and therefore in need of improvement.

The object of the present invention is to propose an alternative and/or improved device for adjusting vanes of an air outlet and a corresponding air outlet, wherein the improvement lies in particular in providing the desired functionality using relatively few and/or simple components.

According to the invention, this object is achieved by a device having the features of the main claim and by an air outlet having the features of the independent claim. Possible embodiments and developments can be found in the dependent claims and the following description.

A device for adjusting vanes of an air outlet is proposed, comprising a motor having an output shaft for selectively adjusting a first part of the vanes and a second part of the vanes different from the first, a motor crank driven by the output shaft and rotatable about a main rotation axis comprising a first actuation element and a second actuation element, a first adjustment crank rotatable about a first rotation axis and having a first engagement element in which the first actuation element engages or is engageable for rotating the first adjustment crank, and a second adjustment crank rotatable about a second rotation axis and having a second engagement element in which the second actuation element engages or is engageable for rotating the second adjustment crank. The first adjustment crank is configured to adjust the first part of the vanes and the second adjustment crank is configured to adjust the second part of the vanes in order to guide an air flow of the air outlet in a targeted manner.

Through the interaction of the motor crank, the first adjustment crank and the second adjustment crank claimed here, a functional and at the same time comparatively simple drive mechanism for adjusting the two parts of the vanes is provided by means of just one motor having one output shaft.

### SUMMARY

In the present case, a crank is to be understood as a rotatable mechanical transmission element, the power of which is transmitted to another transmission element via a lever effect on one side—in the present case, for example, by means of one of the actuation elements on the corresponding engagement element—and is thus in particular distinguished from a rolling wheel or rolling gear, the power of which is transmitted by rolling. Examples of crank mechanisms in which cranks are used are the crank-rocker and the Geneva mechanism.

The main rotation axis, the first rotation axis and the second rotation axis can be parallel to one another. The main rotation axis and the first rotation axis can be spaced apart from one another. The main rotation axis and the second rotation axis can be either spaced apart or coaxial. The motor crank, the first adjustment crank and/or the second adjustment crank can be rotatable about the respective rotation axes about pivot joints that are fixed relative to an air outlet housing in which the vanes are arranged and through which the air flow is guided. In other words, on the air outlet housing, the motor crank can be mounted in a pivot joint so as to be rotatable about the main rotation axis, the first adjustment crank can be mounted in a pivot joint so as to be rotatable about the first rotation axis and/or the second adjustment crank can be mounted in a pivot joint so as to be rotatable about the second rotation axis.

The second actuation element can engage in the second engagement element only along a partial revolution of the motor crank about the main rotation axis. One complete revolution describes a center angle of 360°. Accordingly, a partial revolution is less than 360°. In other words, it may be provided that the motor crank is coupled or connected to the second adjustment crank via the second actuation element and the second engagement element only along part of its revolution about the main rotation axis. A resulting center angle of the partial revolution can be between 180° and 45°, in particular between 140° and 60°.

The device can further comprise a transmission gear arranged between the output shaft and the motor crank. The resulting gear ratio can be less than one, in particular 0.5. An angular velocity of the motor crank around the main rotation axis can then be greater than an angular velocity of the output shaft. The transmission gear can comprise a plurality of rolling wheels via which the output shaft is coupled to the motor crank. In this case, a rolling wheel is understood to mean a gear or friction wheel that can transmit a torque to an engagement element either via positive locking (gear) or friction locking (friction wheel).

The first engagement element can be designed as a lever extending radially away from the first rotation axis. The lever can be a rod-shaped lever. The first engagement element can comprise a groove guide in which the first actuation element engages and along which the first actuation element is movable. It can therefore be provided that the first actuation element permanently engages in the first engagement element regardless of the rotational position of the motor crank. The groove guide can extend radially away from the first rotation axis. The groove guide can be a straight groove guide. In particular, the first engagement element can be designed as a lever with the groove guide running along the lever such that the motor crank and the first adjustment crank interact as an inverted slider crank as a result.

The second adjustment crank can be designed as a rolling wheel, in particular as a partial rolling wheel. A center angle of the partial rolling wheel can be between 180° and 45°, in particular between 140° and 60°. This center angle can correspond to the center angle described above at which the second actuation element engages in the second engagement element. The second engagement element can be designed as a projection, in particular as a projection on the partial rolling wheel. The projection can extend in a radial direction of the second rotation axis such that, depending on the direction of rotation of the motor crank, the second actuation element can engage in the projection from two opposite sides. It can therefore be provided that if the second actuation element were in engagement with the projection from one side and the direction of rotation of the motor crank is then reversed, said motor crank must first complete almost an entire revolution before the second actuation element engages in the projection again from the other side, engagement of the second actuation element in the second engagement element thus being dependent on the rotational position of the motor crank and thus being, for example, only temporary and not permanent. Furthermore, two stop elements can be provided, between which the second adjustment crank and in particular a second adjustment crank designed as a partial rolling wheel can rotate. The stop elements can be formed on the air outlet housing.

The motor crank can be designed as a lever, in particular as a rod-shaped lever, which extends away from the main rotation axis. Alternatively, the motor crank can be designed as a disk, in particular a circular disk, which is rotatable about the main rotation axis. The first actuation element and the second actuation element can be arranged on different, in particular opposite, sides of the motor crank. For example, they can each be designed as a pin that extends parallel to the main rotation axis. The first and second engagement elements can then be arranged on opposite sides of the motor crank.

Alternatively, the first actuation element and the second actuation element can each be designed as levers, in particular as rod-shaped levers, which each extend radially away from the main rotation axis. An angle formed between the first and the second actuation element can be between 180° and 90°, in particular between 120° and 100°. The first engagement element can also be designed as a lever, in particular as a rod-shaped lever extending away from the first rotation axis, and the second engagement element can be designed as a lever, in particular as a rod-shaped lever extending away from the second rotation axis. The first and second actuation elements as well as the first and second engagement elements can be designed and arranged such that if the first actuation element engages in the first engagement element, the second actuation element cannot engage in the second engagement element, and vice versa. The device can further comprise a first, second, third and fourth positioning crank, each having a first arm and a second arm, wherein the first actuation element is engageable in the first arm of the first and second positioning cranks and the second actuation element is engageable in the first arm of the third and fourth positioning cranks, and wherein the second arm of the first and second positioning cranks is engageable in the first engagement element and the second arm of the third and fourth positioning cranks is engageable in the second engagement element in each case. The first, second, third and fourth positioning cranks can be arranged such that either the first or the second positioning crank couples a rotation of the motor crank to the first adjustment crank in a predetermined region or either the third or the fourth positioning crank couples a rotation of the motor crank to the second adjustment crank in a predetermined region. The four positioning cranks can be configured to align the first and second actuation elements and the first and second engagement elements relative to one another in predetermined regions. It can therefore be provided that engagement of the first actuation element in the first engagement element and engagement of the second actuation element in the second engagement element is dependent on the rotational position of the motor crank and is thus, for example, only temporary and not permanent in each case. The four positioning cranks can each be mounted on the air outlet housing in a pivot joint so as to be rotatable about a rotation axis. The rotation axes can each be parallel to one another and in particular parallel to the main rotation axis, the first rotation axis and/or the second rotation axis and/or be spaced apart therefrom. The first and second arms can each extend radially away from the corresponding rotation axis. Each of the four positioning cranks can further comprise a third arm, which also extends radially away from the corresponding axis of rotation. The third arm can be arranged between two stop elements so that the positioning crank is only rotatable in predetermined regions between the two stop elements.

The motor crank, the first adjustment crank and the second adjustment crank can collectively be arranged on a first side of an air outlet housing in which the vanes are arranged and through which the air flow is guided, and the motor can also be arranged on the first side of the air outlet housing or, alternatively, on a second side different from the first side and in particular opposite the first side. The transmission gear can be arranged on the corresponding same side as the motor.

The first part of the vanes can be adjustable by the first adjustment crank, in particular a first drive element of the first adjustment crank, via a first output element that is in engagement with or can be brought into engagement with the first adjustment crank. The second part of the vanes can be adjusted by the second adjustment crank, in particular a second drive element of the second adjustment crank, via a second output element that is in engagement with or can be brought into engagement with the second adjustment crank. In other words, the first output element can be connected to the first part of the vanes in order to adjust their position, in particular collectively, about the first tilting axis. The second output element can be connected to the second part of the vanes in order to adjust their position, in particular collectively, about the second tilting axis. The first output element, the second output element, the first drive element and/or the second drive element can be designed as a partial rolling wheel, in particular as a partial friction wheel. A center angle of a corresponding partial rolling wheel can be between 180° and 45°, in particular between 140° and 60°.

The motor crank can be formed integrally with the first and second actuation elements. The first adjustment crank can be formed in one piece with the first engagement element and/or the first drive element. The second adjustment crank can be formed in one piece with the second engagement element and/or the second drive element. Said elements can be formed monolithically in one piece.

The first part of the vanes can be configured to rotate the air flow about a first tilting axis and the second part of the vanes can be configured to rotate the air flow about a second tilting axis that is orthogonal to the first tilting axis.

For example, one part of the vanes can be designed to adjust the air flow vertically when viewed relative to a vehicle interior, for example, while the other part of the vanes can be designed to adjust the air flow horizontally. The first or second tilting axis can run parallel to the main rotation axis, the first rotation axis and/or the second rotation axis.

In addition, an air outlet having a device according to any of the aforementioned examples is proposed. The air outlet can be an air outlet for a vehicle interior. The air outlet can be a ventilation system of a vehicle interior.

The specific design of the individual elements described above and their interaction, for example the center angles of any partial rolling wheels and/or the interaction of individual elements as an inverted slider crank and/or the temporary or permanent engagement of the corresponding actuation elements, engagement elements and/or positioning cranks, can be provided in such a way that the two parts of the vanes can be selectively adjusted in a predetermined manner. This may, for example, also depend on the appropriate rotational freedom of each of the two parts of the vanes.

In the present case, several embodiments have been disclosed. Further embodiments and advantageous combinations of individual features will become clear to those skilled in the art from the following detailed description, which discloses and describes four embodiments of the invention given by way of example. Accordingly, the drawings and the detailed description are to be regarded as illustrative and not limiting. Recurring features are provided with the same reference signs in the figures.

### DESCRIPTION OF THE FIGURES

FIG. 1 is a plan view of an example air outlet with a first embodiment of a device according to the invention,

FIG. 2 is a perspective view of the air outlet from FIG. 1,

FIG. 3 is a detailed perspective view of the device from FIG. 1,

FIG. 4 is a plan view of an air outlet with a second embodiment of a device according to the invention,

FIG. 5 is a perspective view of the air outlet from FIG. 4,

FIG. 6 is a detailed exploded perspective view of the device from FIG. 4,

FIG. 7 is a plan view of an air outlet with a third embodiment of a device according to the invention,

FIG. 8 is a perspective view of the air outlet from FIG. 7,

FIG. 9 is a detailed exploded perspective view of the device from FIG. 7,

FIG. 10 is a plan view of an air outlet with a fourth embodiment of a device according to the invention,

FIG. 11 is a perspective view of the air outlet from FIG. 10,

FIG. 12 is another perspective view of the air outlet from FIG. 10,

FIG. 13 is a detailed view of the basic functional principle of the device from FIG. 1 according to five different positions, and

FIG. 14 is a detailed view of the basic functional principle of the device from FIG. 10 according to eight different positions.

### DETAILED DESCRIPTION

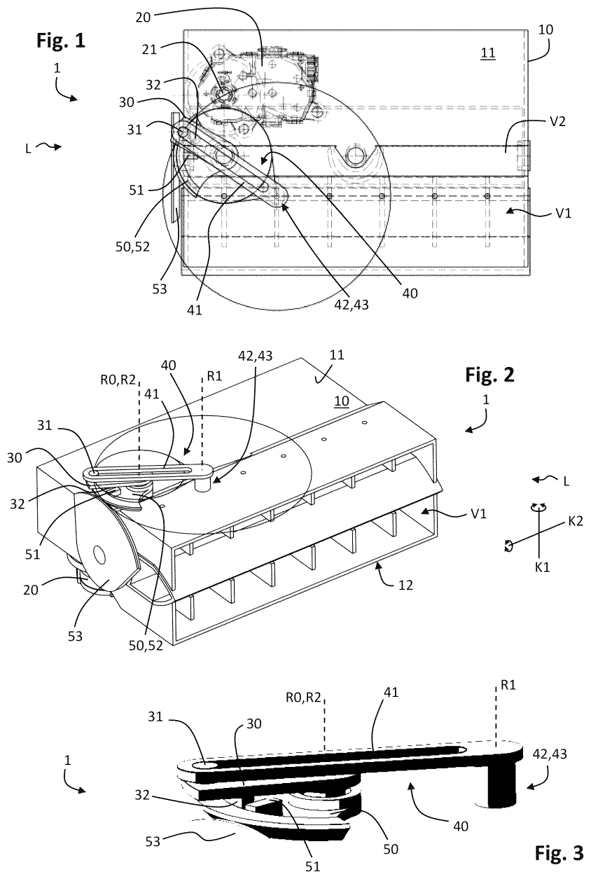

FIGS. 1 to 12 each show an example air outlet L having four different exemplary embodiments of a device according to the invention 1; 2; 3; 4. In the following, some recurring features will be described once for all the drawings. Reference to specific drawings or embodiments is made only where appropriate. To better illustrate selected rotational movements or corresponding degrees of freedom, these are shown in some of the figures by means of solid circles.

The device 1; 2; 3; 4 for adjusting vanes V1, V2 of an air outlet L comprises a motor 20 having an output shaft 21 for selectively adjusting a first part V1 of the vanes V1, V2 and a second part V2 of the vanes V1, V2 different from the first, a motor crank 30 driven by the output shaft 21 and rotatable about a main rotation axis R0 and comprising a first actuation element 31 and a second actuation element 32, a first adjustment crank 40 rotatable about a first rotation axis R1 and having a first engagement element 41 in which the first actuation element 31 engages or is engageable for rotating the first adjustment crank 40, and a second adjustment crank 50 rotatable about a second rotation axis R2 and having a second engagement element 51 in which the second actuation element 32 engages or is engageable for rotating the second adjustment crank 50. The first adjustment crank 40 is configured to adjust the first part V1 of the vanes V1, V2 and the second adjustment crank 50 is configured to adjust the second part V2 of the vanes V1, V2 in order to guide an air flow of the air outlet L in a targeted manner.

Due to the interaction between the motor crank 30, the first adjustment crank 40 and the second adjustment crank 50, a particularly functional and at the same time comparatively simple drive mechanism for adjusting the two parts of the vanes V1, V2 is provided by means of just one motor 20 having one output shaft 21. The features mentioned below further contribute to this effect, in particular insofar as they interact, for example mechanically. For example, cranks thus represent a structurally very simple and at the same time functionally versatile type of power transmission, in particular insofar as selectively predetermined transmission regions are to be provided.

The air outlet L can be part of a ventilation system of a vehicle interior. The first part V1 of the vanes V1, V2 is configured to rotate the air flow about a first tilting axis K1 and the second part V2 of the vanes V1, V2 is configured to rotate the air flow about a second tilting axis K2 that is orthogonal to the first tilting axis K1. Depending on the coupling between the vanes V1, V2 and the device 1; 2; 3; 4, the first part V1 of the vanes is configured to adjust the air flow vertically, for example when viewed relative to a vehicle interior, while the second part V2 of the vanes V1, V2 is configured to adjust the air flow horizontally, as is the case for example for embodiments one, two and four (cf. FIGS. 2, 5 and 11), or vice versa, as is the case for example for embodiment three (cf. FIG. 8). Therefore, the corresponding vanes V1, V2 can be referred to as vertical or horizontal vanes. Thus, according to all the illustrations, the air outlet L comprises six vertical vanes and one horizontal vane, each of which extends through an air outlet housing 10 and is mounted therein about fixed rotation axes. In the present case, the air outlet housing 10 has a first side 11 and an opposite second side 12, both of which run perpendicularly to the vertical vanes and between which the vanes V1, V2 are arranged. The first and second sides 11, 12 of the air outlet housing are connected to one another by two opposite transverse sides in this case, both of which run perpendicularly to the horizontal vane and between which the vanes V1, V2 are arranged.

The main rotation axis R0, the first rotation axis R1 and the second rotation axis R2 are parallel to each other. According to the first, second and fourth embodiments, the first tilting axis K1 runs parallel to the main rotation axis R0, the first rotation axis R1 and the second rotation axis R2, and according to the third embodiment, the second tilting axis K2 runs parallel to said rotation axes. The main rotation axis R0 and the first rotation axis R1 are spaced apart from one another. The main rotation axis R0 and the second rotation axis R2 may be either spaced apart from one another, as shown in embodiment four, or be coaxial, as shown in embodiments one, two and three. The motor crank 30, the first adjustment crank 40 and the second adjustment crank 50 are rotatable about the respective rotation axes R0, R1, R2 about pivot joints fixed relative to the air outlet housing L in which the vanes V1, V2 are arranged and through which the air flow is guided. In other words, on the air outlet housing 10, the motor crank 30 is mounted in a pivot joint so as to be rotatable about the main rotation axis R0; the first adjustment crank 40 is mounted in a pivot joint so as to be rotatable about the first rotation axis R1; and the second adjustment crank 50 is mounted in a pivot joint so as to be rotatable about the second rotation axis R2.

The second actuation element 32 engages in the second engagement element 51 only along a partial revolution of the motor crank 30 about the main rotation axis R0. In other words, it is provided that the motor crank 30 is coupled or connected to the second adjustment crank 51 via the second actuation element 32 and the second engagement element 51 only along part of its revolution about the main rotation axis R0. As a result, the vanes V1 or V2 coupled to the second adjustment crank 50 can be adjustable or even actuatable depending on a relative position of the motor crank 30 and the second adjustment crank 50. The resulting center angle of the partial revolution can be between 180° and 45°. In the embodiments shown here, this angle is between 140° and 60° and can in principle depend on the appropriate rotational freedom of the vanes V1 or V2 coupled to the second adjustment crank 50.

The device 1; 2; 3; 4 further comprises a transmission gear 25 arranged between the output shaft 21 and the motor crank 30, wherein the transmission gear 25 is only visible in embodiments 2 and 3. The resulting gear ratio can be less than one, in particular 0.5. An angular velocity of the motor crank 30 about the main rotation axis R0 can then be greater than an angular velocity of the output shaft 21, which increases the sensitivity of an adjustment process. The transmission gear 25 comprises a plurality of—in this case three—rolling wheels 26, 27, 28 via which the output shaft 21 is coupled to the motor crank 30. The rolling wheels 26, 27, 28 are designed as friction wheels in this case. Moreover, this also applies to all rolling wheel structures explained below. Alternatively, toothed elements, such as gearwheels or partial gearwheels, can also be used for these rolling wheel structures.

In the present case, the first engagement element 41 is designed as a rod-shaped lever extending radially away from the first rotation axis R1. According to the embodiments in FIGS. 1 to 9, the first engagement element 41 comprises a groove guide in which the first actuation element 31 engages and along which the first actuation element 31 is movable. It is therefore provided that the first actuation element 31 permanently engages in the first engagement element 41 regardless of the rotational position of the motor crank 30. The groove guide extends radially away from the first rotation axis R1 in a straight line. Thus, the first engagement element 41 is designed as a lever with the groove guide running along the lever such that the motor crank 30 and the first adjustment crank 40 interact as an inverted slider crank as a result.

Furthermore, in the first three embodiments in FIGS. 1 to 9, the second adjustment crank 50 is designed as a rolling wheel and in particular, in the present case, as a partial rolling wheel. A center angle of the partial rolling wheel can be between 180° and 45°. In this case, it is between 140° and 60°. This center angle corresponds to the center angle described above at which the second actuation element 32 engages in the second engagement element 51. The second engagement element 51 is designed as a projection on the partial rolling wheel, wherein the projection extends in a radial direction of the second rotation axis R2 such that, depending on the direction of rotation of the motor crank 30, the second actuation element 32 can engage in the projection from two opposite sides. It is therefore provided that if the second actuation element 32 was engaged with the projection from one side and the direction of rotation of the motor crank 30 is then reversed, said motor crank must first complete almost an entire revolution before the second actuation element 32 engages in the projection again from the other side, engagement of the second actuation element 32 in the second engagement element 51 thus being dependent on the rotational position of the motor crank 30 and thus being, for example, only temporary and not permanent. Furthermore, at least in embodiments two and three, two stop elements 16, 17 are provided, between which the second adjustment crank 50 designed as a partial rolling wheel is rotatable. The stop elements 16, 17 limit the rotational freedom of the partial rolling wheel. For example, the connection between the second adjustment crank 50 and the second output element 53 can be prevented from releasing.

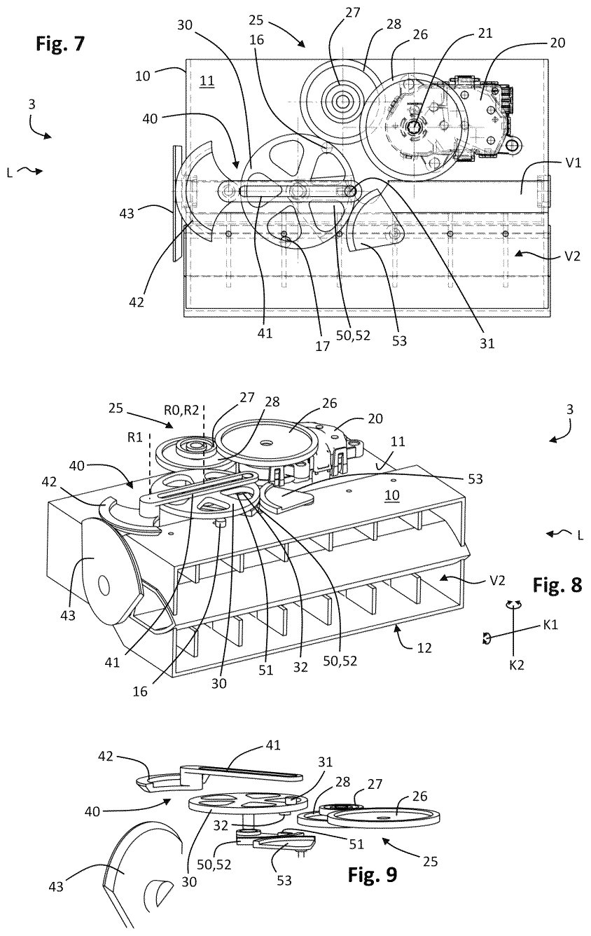

In the first two embodiments in FIGS. 1 to 6, the motor crank 30 is designed as a rod-shaped lever extending away from the main rotation axis R0. As an alternative, in the third embodiment according to FIGS. 7 to 9, the motor crank 30 is designed as a circular disk that is rotatable about the main rotation axis R0. In both cases, the first actuation element 31 and the second actuation element 32 are arranged on different, and in this case in particular opposite, sides of the motor crank 30. They are each designed as a pin extending parallel to the main rotation axis R0. The first and second engagement elements 41, 51 are then arranged on the opposite sides of the motor crank 30.

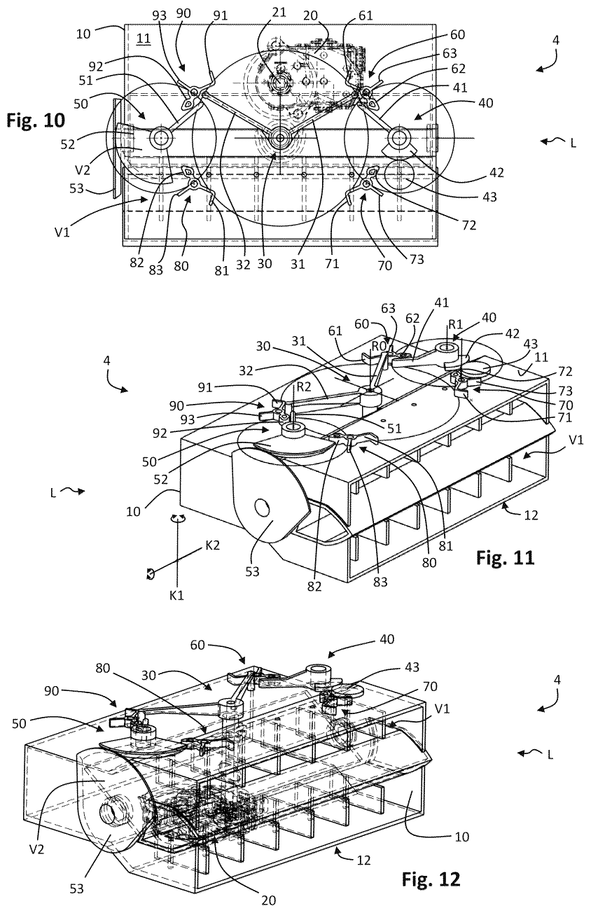

In the fourth embodiment according to FIGS. 10 to 12, the first actuation element 31 and the second actuation element are each designed as rod-shaped levers, wherein these extend radially away from the main rotation axis R0. An angle formed between the first and the second actuation elements can be between 180° and 90°. In this case, this angle is between 120° and 100°.

In addition, the first engagement element 41 and the second engagement element 51 are designed as rod-shaped levers that accordingly extend away from the first rotation axis R1 or the second rotation axis R2. The first and second actuation elements 31, 32 as well as the first and second engagement elements 41, 51 are designed and arranged such that if the first actuation element 31 engages in the first engagement element 41, the second actuation element 32 cannot engage in the second engagement element 51, and vice versa. This makes it possible to adjust either the first part V1 or the second part V2 of the vanes V1, V2. Furthermore, the device according to the fourth embodiment comprises a first, second, third and fourth positioning crank 60, 70, 80, 90, each with a first arm 61, 71, 81, 91 and a second arm 62, 72, 82, 92, wherein the first actuation element 31 is engageable in the first arm 61, 71 of the first and second positioning cranks 60, 70 and the second actuation element 32 is engageable in the first arm 81, 91 of the third and fourth positioning cranks 80, 90, and wherein the second arm 62, 72 of the first and second positioning cranks 60, 70 is engageable in the first engagement element 41 and the second arm 82, 92 of the third and fourth positioning cranks 80, 90 is engageable in the second engagement element 51. The first, second, third and fourth positioning cranks 60, 70, 80, 90 are arranged such that either the first or the second positioning crank 60, 70 couples a rotation of the motor crank 30 to the first adjustment crank 40 in a predetermined region or either the third or the fourth positioning crank 80, 90 couples a rotation of the motor crank 30 to the second adjustment crank 50 in a predetermined region. The four positioning cranks 60, 70, 80, 90 are configured to align the first and second actuation elements 31, 32 and the first and second engagement elements 41, 52 relative to one another in predetermined regions. It is therefore provided in the present case that engagement of the first actuation element 31 in the first engagement element 41 and engagement of the second actuation element 32 in the second engagement element 51 is dependent on the rotational position of the motor crank 30 and is thus only temporary and not permanent in each case. The four positioning cranks 60, 70, 80, 90 are each mounted on the air outlet housing 10 in a pivot joint so as to be rotatable about a rotation axis. Each of the rotation axes are parallel to one other and also parallel to the main rotation axis R0, the first rotation axis R1 and the second rotation axis R2 and are spaced apart therefrom. The first and second arms 61, 71, 81, 91, 62, 72, 82, 92 extend radially away from the corresponding axis of rotation.

Each of the four positioning cranks 60, 70, 80, 90 further comprises a third arm 63, 73, 83, 93, which also extends radially away from the corresponding rotation axis. The third arm 63, 73, 83, 93 can be arranged between two stop elements (not shown here) each time so that each positioning crank 60, 70, 80, 90 can only rotate in predetermined regions between the two stop elements.

The motor crank 30, the first adjustment crank 40 and the second adjustment crank 50 can collectively be arranged on the first side 11 of the air outlet housing 10 in which the vanes V1, V2 are arranged and through which the air flow is guided, and the motor 20 can also be arranged on the first side 11 of the air outlet housing 10, or, alternatively, on the opposite second side 12. The transmission gear 25 is arranged on the corresponding same side as the motor 20. This may in principle be dependent on the available installation space and the specific design of the elements driven by the motor 20 and coupled to one another. For example, in the fourth embodiment, it is expedient in this case that the motor 20 and, accordingly, the transmission gear 25 are arranged on the second side 12. This is also the case for the first embodiment. In contrast, in embodiments two and three, the motor 20 and transmission gear are arranged on the first side 11 together with the motor crank 30, the first adjustment crank 40 and the second adjustment crank 50. In the latter variant, the corresponding air outlets L can be made more compact overall.

The first part V1 or V2 (V1 in embodiments one, two and four, V2 in embodiment three) of the vanes V1, V2 is adjustable by the first adjustment crank 40, in particular a first drive element 42 of the first adjustment crank 40, via a first output element 43 that is in engagement with or can be brought into engagement with the first adjustment crank 40. The second part V2 or V1 (this is accordingly V2 in embodiments one, two and four, and V1 in embodiment three) of the vanes V1, V2 is adjustable by the second adjustment crank 50, in particular a second drive element 52 of the second adjustment crank 50, via a second output element 53 that is in engagement with or can be brought into engagement with the second adjustment crank 50. Thus, the first output element 43 is connected to the corresponding first part of the vanes V1, V2 in order to collectively adjust their position about the first tilting axis K1. The second output element 53 is connected to the corresponding second part of the vanes V1, V2 in order to collectively adjust their position about the second tilting axis. In each of the four embodiments shown here, the second output element 53 and the second drive element 52 are designed as a partial friction wheel. In the fourth embodiment, the first drive element 42 is also designed as a partial friction wheel, and in the third embodiment, the first drive element 42 and the first output element 43 are also designed as a partial friction wheel. A center angle of the corresponding partial friction wheels can be between 180° and 45°. In this case, it is between 140° and 60°. In the embodiments shown, the horizontal vane is connected to the corresponding output element 53 (devices 1, 2 and 4) or 43 (device 3) mounted on one of the two transverse sides via a shaft extending between the transverse sides of the air outlet housing 10 for conjoint rotation therewith. The other output element 43 (devices 1, 2 and 4) or 53 (device 3), which is mounted on the first side 11 in the present case, is connected to one of the vertical vanes via a shaft extending between the first and second sides 11, 12 of the air outlet housing for conjoint rotation therewith, which vertical vane is, in turn, then connected to the remaining vertical vanes via a coupling shaft (not shown here).

The motor crank 30 is monolithically formed in one piece with the first and second actuation elements 31, 32. The first adjustment crank 40 is monolithically formed in one piece with the first engagement element 41 and the first drive element 42. The second adjustment crank 50 is monolithically formed in one piece with the second engagement element 51 and the second drive element 52. Apart from less manufacturing effort for the individual parts, the single-piece design can also contribute to reducing the complexity of each device 1; 2; 3; 4.

The structure of the four embodiments of the device 1; 2; 3; 4, in particular each of the drive mechanisms and their characteristics, is briefly described in detail below. What all four embodiments have in common here is that, among other things, the output shaft 21 of the motor 20 drives the motor crank 30 via a transmission gear 25 and sets said motor crank in rotation about a main rotation axis R0 depending on the direction of rotation of the output shaft 21. In the drawings, the transmission gear 25 is only visible in the embodiments in which the motor 20 and the transmission gear 25 are arranged on the first side 11 of the air outlet housing 10, i.e. embodiments two and three.

In the first embodiment (FIGS. 1 to 3), the motor crank 30 is designed as a rod-shaped lever having two actuation elements 31, 32 or pins arranged on opposite sides of the motor crank 30. The first actuation element 31 engages permanently, i.e. independently of the rotational position and direction of the motor crank 30, in the groove guide of the first engagement element 41. The first engagement element 41 is designed as a lever on the first adjustment crank 40. The first adjustment crank 40 is rotatable about the first rotation axis R1 in a pivot joint that is fixedly mounted on the first side 11 of the air outlet housing 10. The first rotation axis R1 is spaced apart from the main rotation axis R0 so that the motor crank 30 and the first adjustment crank 40 interact as an inverted slider crank. The first adjustment crank 40 comprises, in the region of its pivot joint, a first drive element 42 connected to the first part V1 of the vanes V1, V2, which first drive element corresponds to the vertical vanes here, via a first output element 43 also arranged in the region of the pivot joint. As indicated in FIGS. 1 and 2, the first drive element 42 is designed as a sleeve and the first output element 43 is designed as a shaft that is received in the sleeve and engages therewith. Due to the permanent engagement between the first actuation element 31 and the first engagement element 41 in this case, the position of the vertical vanes is directly coupled to the rotational position of the motor crank 30. This is not the case for the horizontal vane, i.e. the second part V2 of the vanes V1, V2 in this case. Thus, the second engagement element 51 is designed as a projection on the second adjustment crank 50, wherein the second actuation element 32 of the motor crank 30 can be brought into engagement with the second engagement element 51 from opposite sides depending on the direction and position of rotation of the motor crank 30. In contrast to the first actuation element 31, the second actuation element 32 is thus configured to engage in the second engagement element 51 only temporarily. The second adjustment crank 50 is further designed as a partial friction wheel that is rotatably mounted in a common joint together with the motor crank 30 on the first side 11. The corresponding second rotation axis R2 of the second adjustment crank 50 and the main rotation axis R0 of the motor crank 30 are thus arranged coaxially. The second adjustment crank 50, which is designed as a partial friction wheel, simultaneously acts as a second drive element 52 that engages with the second output element 53 at least when the second adjustment crank 50 is properly aligned. The second output element 53 is mounted on a transverse side of the air outlet housing 10 and connected to the horizontal vane for conjoint rotation. Insofar as the second drive element 52 is in driving engagement with the second output element 53 and the second actuation element 32 is in driving engagement with the second engagement element 51 when the motor crank 30 rotates, the position of the horizontal vane is directly coupled to the rotation of the motor crank 30.

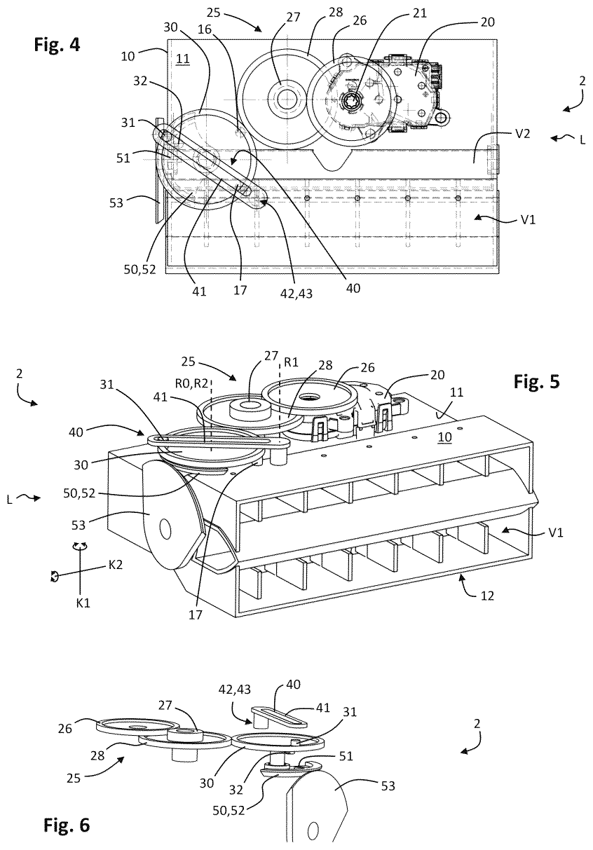

The second embodiment (FIGS. 4 to 6) in principle has a similar design to the first embodiment. A significant difference with respect to the first embodiment is that the motor crank 30 is designed as a circular disk. The reason for this is that both the transmission gear 25 and the motor crank 30 are arranged on the first side 11. Thus, in this case the motor crank 30 simultaneously functions as a friction wheel that is in engagement with the transmission gear 25—and more precisely with the rolling wheel 28 of the transmission gear 25, which is also designed as a friction wheel. In addition, two stop elements 16, 17 are formed on the first side 11, which limit the rotation of the second adjustment crank to a predetermined region. This region corresponds to the region in which the second drive element 52 and the second output element 53 are in engagement with one another.

In the third embodiment (FIGS. 7 to 9), the roles of the first adjustment crank 40 and the second adjustment crank 50 and thus also the roles of the first part V1 and the second part V2 of the vanes V1, V2 are swapped with respect to the second embodiment, i.e. while the first adjustment crank 40, which is permanently coupled to the motor crank 30, adjusts the horizontal vane, the vertical vanes are adjusted by the second adjustment crank 50, which is only temporarily coupled to the motor crank 30. This has the effect that while an adjustment of the horizontal vanes inevitably also initially led to an adjustment of the vertical vanes in embodiments one and two, this is now reversed. This may be desirable, for example, if the horizontal vane is arranged behind the vertical vanes and is harder or impossible to see when viewed from a space ventilated or to be ventilated by the air outlet L, for example a vehicle interior. Further substantial design differences between the third embodiment and the second embodiment are in particular the design and interaction of the driving and/or driven elements. For example, in the present case, the first adjustment crank 40 comprises a partial friction wheel that functions as a drive element 42 and is engaged or can be engaged with the first output element 43, which is arranged on one of the transverse sides of the air outlet housing and is also designed as a partial friction wheel and is connected to the horizontal vanes. The second output element 53, on the other hand, is mounted on the first side 11 of the air outlet housing 10 and is connected to the vertical vanes.

In the fourth embodiment (FIGS. 10 to 12), in contrast to the first three embodiments, both the first adjustment crank 40 and the second adjustment crank 50 are only temporarily coupled to the motor crank 30. Thus, the first part V1 of the vanes V1, V2 (once again the vertical vanes here) can be adjusted without adjusting the second part V2 of the vanes V1, V2 (correspondingly once again the horizontal vane), and vice versa. The design of the motor crank 30, the first adjustment crank 40, the second adjustment crank 50 and the four positioning cranks 60, 70, 80, 90 shown here in this regard has already been explained in detail above. As a result, the first or second actuation element 31, 32 of the motor crank 30 only ever actuates the corresponding first or second engagement element 41, 51 of the first or second adjustment crank 40, 50 from one side, wherein switching between the two sides of the respective engagement elements 41, 51 is effected by the corresponding first and second positioning cranks 60, 70 or third and fourth positioning cranks 80, 90, which move the relevant actuation element 31, 32 to the other side.

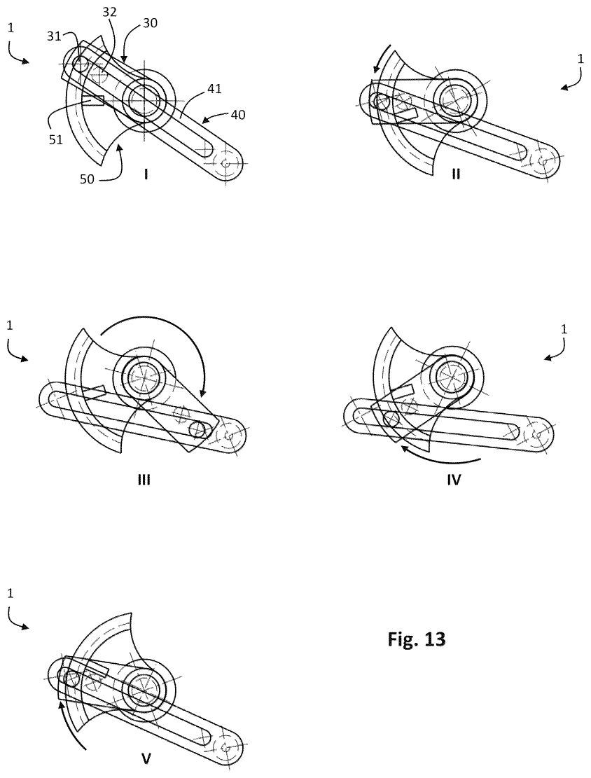

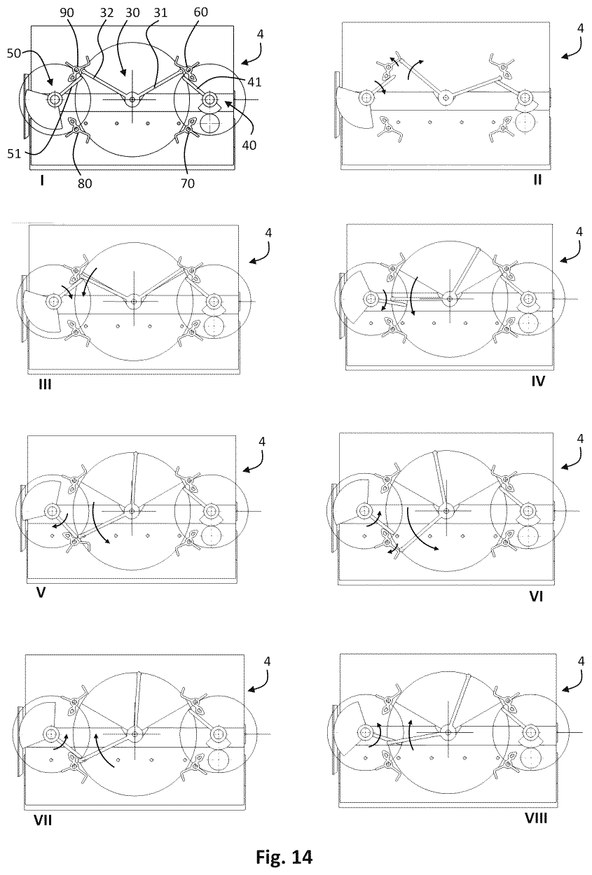

Finally, the basic functional principle of the claimed device 1; 2; 3; 4 is explained in more detail below by means of FIGS. 13 and 14, using the first embodiment and the fourth embodiment as examples. Selected rotational movements of individual elements are represented by circular arrows.

FIG. 13 shows, by way of example, five different positions of the motor crank 30 and the first and second adjustment cranks 40, 50 of the device 1 according to FIGS. 1 to 3, which are or can be coupled to said motor crank. Position I represents an example starting position in which the second actuation element 31 is not yet engaged with the second engagement element 51. The second actuation element 32 is then brought into engagement with the second engagement element 51 (in this case by rotating the motor lever 30 counter-clockwise) and the horizontal vane, which is coupled to the second adjustment crank 50 in this case, is adjusted to a desired orientation; cf. position II. Then, by reversing the direction of rotation of the motor crank 30 (i.e. clockwise in this case), the engagement of the second actuation element 32 in the second engagement element 51 is released and the vertical vanes coupled in this case to the first adjustment crank 40 are adjusted to a desired orientation; cf. position III, specifically independently of the alignment of the horizontal vane that has already been performed, i.e. without adjusting it. This is possible because the first actuation element 31 and the first engagement element 41 are in permanent engagement, while the second actuation element 32 and the second engagement element 51 can only be brought into engagement temporarily depending on the direction of rotation of the motor crank 30. If the motor crank 30 is now further rotated clockwise until the second actuation element 32 again engages with the second engagement element 51 from the other side; cf. position IV, the horizontal vane can again be adjusted to a desired orientation; cf. position V.

FIG. 14 now shows, by way of example, eight different positions of the motor crank 30 and the first and second adjustment cranks 40, 50 of the device 4 according to FIGS. 10 to 12, which are or can be coupled to said motor crank. Position I represents an example starting position in which the motor crank 30 is not engaged with any other elements. According to position II, the motor crank 30 is rotated clockwise in this case so that the second actuation element 32 engages with the fourth positioning crank 90, and the second engagement element 51 is likewise actuated clockwise so that the second engagement element 51 is positioned so that it can be brought into engagement with the second actuation element 32. After the direction of rotation of the motor crank is reversed (i.e. counterclockwise in this case), the second actuation element 32 is brought into engagement with the second engagement element 51 from an upper side according to the illustration in FIG. 14, cf. position III, such that, by turning the motor crank 30 further, the horizontal vane coupled to the second adjustment crank 50 in this case can be brought into a desired orientation, cf. position IV, until the engagement between the second actuation element 32 and the second engagement element 51 is released, cf. position V. Analogously to position II, turning the motor crank 30 further counterclockwise now leads to the second actuation element 32 coming into engagement with the third positioning crank 80 and the second engagement element 51 likewise now being actuated counterclockwise, such that the second engagement element 51 is positioned in such a way that it can be brought back into engagement with the second actuation element 32, cf. position VI. Further analogously to positions III and IV, after the direction of rotation of the motor crank 30 is reversed (back to clockwise in this case), the second actuation element 32 is brought into engagement with the second engagement element 51 from a now lower side, cf. position VII, so that by turning the motor crank 30 further, the horizontal vane can again be brought into a desired orientation, cf. position VIII. Thus, in the present case, insofar as the second actuation element 32 actuates the second engagement element 51 indirectly (via one of the positioning cranks 90 or 80) or directly (by direct engagement), the horizontal vane coupled to the second adjustment crank 50 can be adjusted to a desired orientation. The vertical vanes coupled to the first adjustment crank 40 in this case remain unaffected, since the only temporary coupling of the motor crank 30, the first and second adjustment cranks 40, 50 and the current choice of the geometric arrangement of the elements involved allow the vanes to be adjusted independently of one another. The vertical vanes could be adjusted to a desired orientation in this case in the same way as in positions II to VIII, but by turning the motor crank 30 clockwise starting from the starting position (position I).

In particular, in view of the last two example adjustment sequences shown, it is clear that the specific design of the individual elements described above and their interaction, for example the center angles of any partial rolling wheels and/or the interaction of individual elements as an inverted slider crank and/or temporary or permanent engagement of the corresponding actuation elements, engagement elements and/or positioning cranks, can be provided in such a way that the two parts of the vanes can be selectively adjusted in a predetermined manner. This may, for example, also depend on the appropriate rotational freedom of each of the two parts of the vanes.

Further embodiments will be obvious to those skilled in the art.

What is claimed is:

1. A device for adjusting vanes of an air outlet, comprising:
a motor having an output shaft for selectively adjusting a first part of the vanes and a second part of the vanes different from the first,
a motor crank driven by the output shaft and rotatable about a main rotation axis comprising a first actuation element and a second actuation element,
a first adjustment crank rotatable about a first rotation axis and having a first engagement element in which the first actuation element engages or is engageable for rotating the first adjustment crank,
a second adjustment crank rotatable about a second rotation axis and having a second engagement element in which the second actuation element engages or is engageable for rotating the second adjustment crank,
wherein the first adjustment crank is configured to adjust the first part of the vanes and the second adjustment crank is configured to adjust the second part of the vanes in order to guide an air flow of the air outlet in a targeted manner.

2. The device according to claim 1, wherein the main rotation axis, the first rotation axis and the second rotation axis are parallel to one another and/or wherein the main rotation axis and the first rotation axis are spaced apart from one another and/or wherein the main rotation axis and the second rotation axis are spaced apart from one another or are coaxial.

3. The device according to claim 1, wherein the motor crank, the first adjustment crank and/or the second adjustment crank are rotatable about the respective rotation axes about pivot joints fixed relative to an air outlet housing in which the vanes are arranged and through which the air flow is guided.

4. The device according to claim 1, wherein the second actuation element engages in the second engagement element only during a partial revolution of the motor crank about the main rotation axis, wherein a resulting central angle of the partial revolution is optionally between 180° and 45°, in particular between 140° and 60°.

5. The device according to claim 1, further comprising a transmission gear arranged between the output shaft and the motor crank, wherein the resulting transmission ratio is less than one, in particular 0.5.

6. The device according to claim 1, wherein the first engagement element is designed as a lever extending radially away from the first rotation axis.

7. The device according to claim 1, wherein the first engagement element comprises a groove guide, in particular a straight groove guide, in which the first actuation element engages and along which the first actuation element is movable, wherein the groove guide optionally extends radially away from the first rotation axis.

8. The device according to claim 1, wherein the second adjustment crank is designed as a rolling wheel, in particular as a partial rolling wheel, and/or wherein the second engagement element is designed as a projection, in particular as a projection on the partial rolling wheel, and, optionally, further comprising two stop elements between which the second adjustment crank is rotatable.

9. The device according to claim 1, wherein the motor crank is designed as a lever extending away from the main rotation axis, or wherein the motor crank is designed as a disk, in particular a circular disk, that is rotatable about the main rotation axis.

10. The device according to claim 1, wherein the first actuation element and the second actuation element are arranged on different, in particular opposite, sides of the motor crank and/or are designed as pins.

11. The device according to claim 1, wherein the first actuation element and the second actuation element are each designed as levers, each extending radially away from the main rotation axis, wherein optionally an angle formed between the first and the second actuation element is between 180° and 90°, in particular between 120° and 100°.

12. The device according to claim 11, further comprising a first, second, third and fourth positioning crank, each having a first arm and a second arm, wherein the first actuation element is engageable in the first arm of the first and second positioning cranks and the second actuation element is engageable in the first arm of the third and fourth positioning cranks and wherein the second arm of the first and second positioning cranks is engageable in the first engagement element and the second arm of the third and fourth positioning cranks is engageable in the second engagement element, wherein the first, second, third and fourth positioning cranks are arranged such that either the first or the second positioning crank couples a rotation of the motor crank to the first adjustment crank in a predetermined region or either the third or the fourth positioning crank couples a rotation of the motor crank to the second adjustment crank in a predetermined region.

13. The device according to claim 1, wherein the motor crank, the first adjustment crank and the second adjustment crank are collectively arranged on a first side of an air outlet housing in which the vanes are arranged and through which the air flow is guided, and the motor is also arranged on the first side of the air outlet housing or on a second side different from the first side and in particular opposite the first side.

14. The device according to claim 1, wherein the first part of the vanes is adjustable by the first adjustment crank, in particular a first drive element of the first adjustment crank, via a first output element that engages with or can be brought into engagement with the first adjustment crank, and the second part of the vanes is adjustable by the second adjustment crank, in particular a second drive element of the second adjustment crank, via a second output element that engages with or can be brought into engagement with the second adjustment crank, wherein optionally the first output element, the second output element, the first drive element and/or the second drive element are designed as a partial rolling wheel, in particular as a partial friction wheel.

15. The device according to claim 1, wherein the first part of the vanes is adapted to rotate the air flow about a first tilting axis and the second part of the vanes is designed to rotate the air flow about a second tilting axis running orthogonally to the first tilting axis, wherein optionally the first or the second tilting axis is parallel to the main rotation axis, the first rotation axis and/or the second rotation axis.

16. An air outlet having a device according to claim 1.
